(19) United States
(12) Patent Application Publication
(10) Pub. No.: US 2026/0187891 A1
(43) Pub. Date: Jul. 2, 2026

(54) SYSTEMS AND METHODS FOR ADJUSTING AN AVATAR MODEL ON THE FLY

(71) Applicants: Constructor Technology AG, Schaffhausen (CH); Constructor Education and Research Genossenschaft, Schaffhausen (CH)

(72) Inventors: Andrei BOIAROV, Sofia (BG); Alexander TORMASOV, Busingen am Hochrhein (DE); Serg BELL, Singapore (SG); Stanislav PROTASOV, Singapore (SG); Nikolay DOBROVOLSKIY, Alanya (TR); Laurent DEDENIS, Geneve (CH)

(21) Appl. No.: 19/003,631

(22) Filed: Dec. 27, 2024

(51) Int. Cl. G06T 13/40; G06T 19/20

(52) U.S. Cl. CPC G06T 13/40; G06T 19/20; G06T 2210/36; G06T 2219/2016; G06T 2219/2021

(57) ABSTRACT

A system receives an avatar model and target specifications for executing the avatar model on a computing device, wherein the avatar model comprises visual characteristics and movement capabilities of an avatar. The system generates, for display on the computing device, the avatar based on the avatar model. The system monitors specifications of the computing device. The system detects a difference between the target specifications and the specifications monitored. The system adjusts, based on the difference, one or more of the visual characteristics and the movement capabilities of the avatar while the avatar is displayed on the computing device.

### FIELD OF TECHNOLOGY

The present disclosure relates to the field of machine learning, and, more specifically, to systems and methods for adjusting an avatar model on the fly.

### BACKGROUND

The creation of an avatar, particularly one that is both realistic and interactive, constitutes a complex and computationally demanding endeavor. This complexity stems from the necessity to replicate human-like features and behaviors, which necessitates the use of advanced algorithms and substantial processing power. The process of generating an avatar typically encompasses several stages, including 3D modeling, texture mapping, rigging, and animation. Each of these stages requires precise calculations and the management of large datasets to ensure that the avatar appears and behaves in a lifelike manner.

The initial step, 3D modeling, involves defining the shape and structure of the avatar. This process necessitates detailed geometric calculations to create a mesh that accurately represents the human form. Following this, texture mapping is applied, where surface details such as skin, hair, and clothing are added to the model. This step involves complex algorithms to ensure that textures are applied seamlessly and realistically.

Rigging represents another computationally intensive task, wherein a skeleton is constructed to facilitate the avatar's movement. This involves establishing a system of bones and joints, which must be meticulously calculated to ensure realistic movement. Finally, animation breathes life into the avatar, requiring sophisticated algorithms to simulate natural human motion and expressions.

Furthermore, if the avatar is intended to be interactive, additional computational resources are required to process user inputs and generate real-time responses. This necessitates the integration of artificial intelligence and machine learning techniques, which further augment the computational demands.

It is evident that the generation of an avatar is a resource-intensive task that demands a combination of advanced software, powerful hardware, and skilled technical expertise to achieve a high degree of realism and interactivity. To make avatars accessible in casual everyday settings where computational resources are limited or fluctuate, there is a need for a system that adjusts avatars on the fly based on various computational factors.

### SUMMARY

The systems and methods described in the present disclosure are designed to simplify avatars by considering user preferences, the availability of computational resources, and the limitations of communication channels. This simplification may be achieved through various optional strategies. These options include reducing active movements and focusing solely on facial and cognitive expressions, such as turning to the side and adopting a thoughtful pose. Additionally, the size of the avatar may be minimized, and the resolution during rendering may be decreased to optimize resource usage.

Utilizing prerecorded videos for gestures is another possibility to ease computational load. Simplification may also involve reducing the level of detail in the avatar's appearance, converting dynamic elements into static ones, and removing reflective layers. A smooth transition to a cartoon-like model is another potential option. Finally, combining geometry likelihood layers, which include both body and appearance, may be considered to enhance resolution and performance, ensuring the avatar remains effective and visually coherent within the specified constraints.

In one exemplary aspect, the techniques described herein relate to a method for adjusting an avatar, the method including: receiving an avatar model and target specifications for executing the avatar model on a computing device, wherein the avatar model includes visual characteristics and movement capabilities of an avatar; generating, for display on the computing device, the avatar based on the avatar model; monitoring specifications of the computing device; detecting a difference between the target specifications and the specifications monitored; and adjusting, based on the difference, one or more of the visual characteristics and the movement capabilities of the avatar while the avatar is displayed on the computing device.

In some aspects, the techniques described herein relate to a method, wherein the target specifications indicate a target set of computational resources and communication channel performance.

In some aspects, the techniques described herein relate to a method, wherein the set of computational resources and communication channel performance includes one or more of: central processing unit (CPU), graphics processing unit (GPU), and random access memory (RAM), storage, bandwidth, latency, and validation resources.

In some aspects, the techniques described herein relate to a method, further including: receiving user experience requirements associated with the avatar model; evaluating a quality of avatar generation; and adjusting, based on the quality of avatar generation, one or more of the visual characteristics and the movement capabilities of the avatar while the avatar is displayed on the computing device.

In some aspects, the techniques described herein relate to a method, wherein evaluating the quality of the avatar generation includes monitoring for user experience feedback generated based on interactions with the avatar.

In some aspects, the techniques described herein relate to a method, wherein evaluating the quality of the avatar generation includes comparing avatar performance against predetermined benchmarks.

In some aspects, the techniques described herein relate to a method, wherein the visual characteristics further include internal characteristics including one or more of: skeleton components and computational characteristics.

In some aspects, the techniques described herein relate to a method, wherein the computational characteristics include one or more of: an amount or size of physical models, Courant number, amount of hairs, amount of textures, amount of polygons.

In some aspects, the techniques described herein relate to a method, wherein adjusting one or more of the visual characteristics and the movement capabilities of the avatar includes performing one or more of: (1) decreasing active movements performed by the avatar, (2) reducing an amount of expressions performed by the avatar, (3) reducing a size of the avatar, (4) decreasing a rendering resolution of the avatar, (5) using prerecorded videos of gestures in place of dynamic animations performed by the avatar, or (6) reducing appearance details on the avatar.

In some aspects, the techniques described herein relate to a method, wherein reducing the appearance details on the avatar includes one or more of: (1) changing dynamic elements of appearance to static, (2) deleting layers with reflections (3) replacing a photo-realistic avatar with a cartoon avatar, or (4) combining geometry likelihood layers.

In some aspects, the techniques described herein relate to a method, wherein the difference indicates that the specifications are lower than the target specifications, further including: re-adjusting one or more of the visual characteristics and the movement capabilities of the avatar when the difference changes.

In some aspects, the techniques described herein relate to a method, wherein adjusting one or more of the visual characteristics and the movement capabilities of the avatar includes executing a machine learning model that recommends an adjustment based on a magnitude of the difference.

In some aspects, the techniques described herein relate to a method, wherein the machine learning model is trained on a training dataset including a plurality of input specification differences and corresponding adjustments.

It should be noted that the methods described above may be implemented in a system comprising at least one hardware processor and memory. Alternatively, the methods may be implemented using computer executable instructions of a non-transitory computer readable medium.

In some aspects, the techniques described herein relate to a system for adjusting an avatar, including: at least one memory; at least one hardware processor coupled with the at least one memory and configured, individually or in combination, to: receive an avatar model and target specifications for executing the avatar model on a computing device, wherein the avatar model includes visual characteristics and movement capabilities of an avatar; generate, for display on the computing device, the avatar based on the avatar model; monitor specifications of the computing device; detect a difference between the target specifications and the specifications monitored; and adjust, based on the difference, one or more of the visual characteristics and the movement capabilities of the avatar while the avatar is displayed on the computing device.

In some aspects, the techniques described herein relate to a non-transitory computer readable medium storing thereon computer executable instructions for adjusting an avatar, including instructions for: receiving an avatar model and target specifications for executing the avatar model on a computing device, wherein the avatar model includes visual characteristics and movement capabilities of an avatar; generating, for display on the computing device, the avatar based on the avatar model; monitoring specifications of the computing device; detecting a difference between the target specifications and the specifications monitored; and adjusting, based on the difference, one or more of the visual characteristics and the movement capabilities of the avatar while the avatar is displayed on the computing device.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram illustrating a system for adjusting an avatar model on the fly.

FIG. 2 is a diagram illustrating an example of a simplified visual appearance of an avatar.

FIG. 3 illustrates a block diagram of a specific approach for adjusting an avatar model on the fly.

FIG. 4 illustrates a flow diagram of a method for adjusting an avatar model on the fly.

FIG. 5 presents an example of a general-purpose computer system on which aspects of the present disclosure may be implemented.

### DETAILED DESCRIPTION

Exemplary aspects are described herein in the context of a system, method, and computer program product for adjusting an avatar model on the fly. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

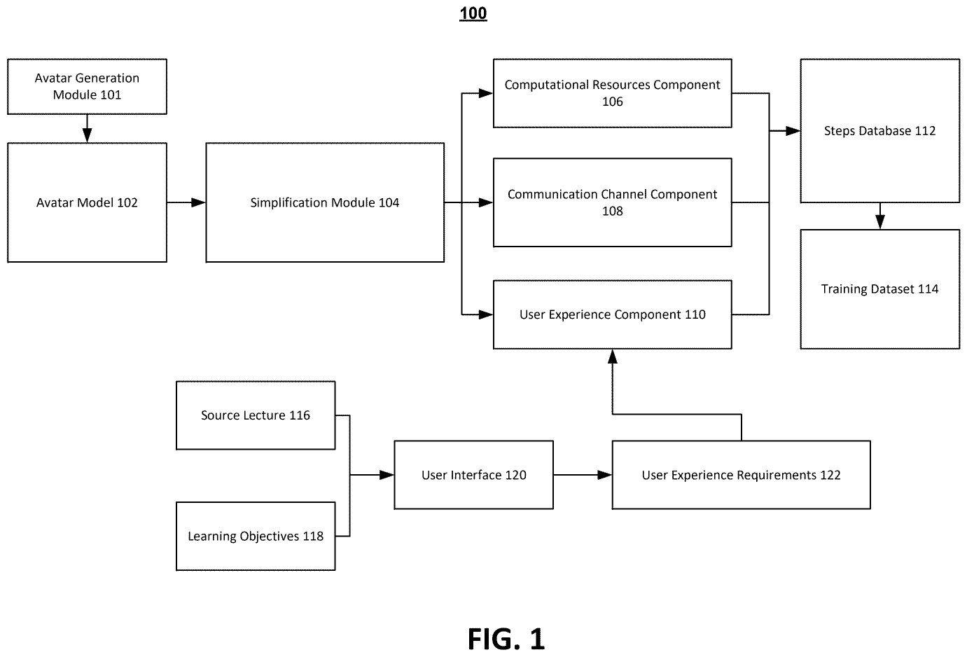

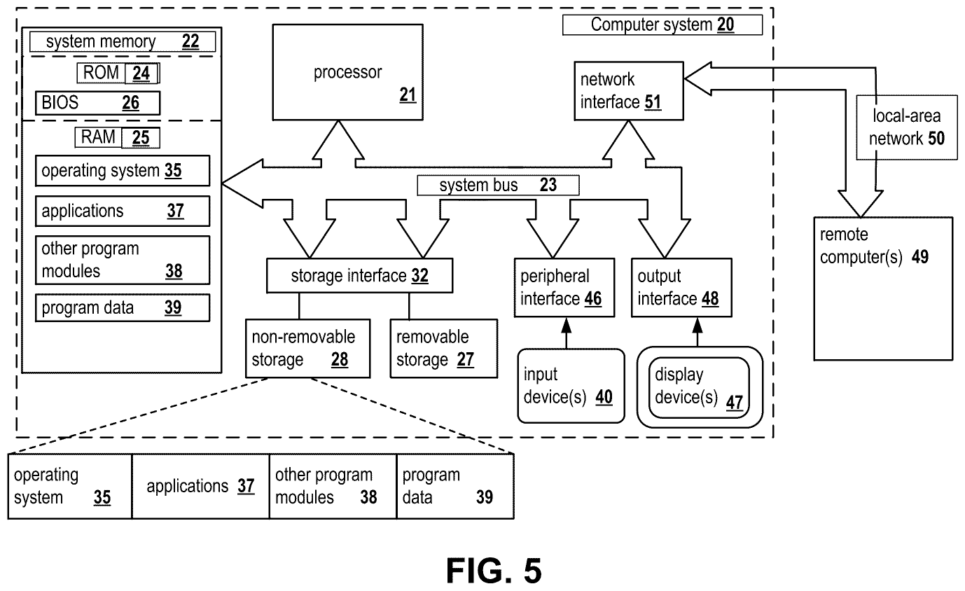

FIG. 1 is a block diagram illustrating system 100 for adjusting an avatar model on the fly. In some aspects, system 100 may be implemented using computer system 20 (described in FIG. 5). For example, datasets and databases may be stored in memory 22 and software actions may be executed by processor 21.

In some aspects, system 100 may be implemented across multiple computer systems. For example, one computer system may generate the initial avatar and another computer system may adjust the visual appearance of the avatar during simplification.

Firstly, avatar generation module 101 may generate avatar model 102. The first step in generating an avatar model is 3D modeling, where the basic structure and form of the avatar are created. This involves using software tools that allow designers to sculpt and shape the avatar's body, face, and other features. The software typically used for this purpose includes programs like Blender, Autodesk Maya, or ZBrush. These tools provide a range of functionalities to create detailed and complex models.

Subsequently avatar generation module 101 may be used to perform texture mapping, where surface details such as skin, hair, and clothing are applied to avatar model 102. This process involves creating and applying textures that give the avatar a realistic appearance.

Avatar generation module 101 may then perform rigging, which is the process of creating a skeleton for the avatar, which allows it to move as desired. This involves setting up a system of bones and joints that may be manipulated to animate the avatar.

Avatar generation module 101 may further perform rendering, where the completed model is processed to produce the final image or animation. This step involves complex calculations to simulate lighting, shadows, and other visual effects. Rendering software such as Arnold, V-Ray, or Unreal Engine is used to achieve high-quality results.

Avatar generation module 101 ultimately outputs avatar model 102, which is input into simplification module 104. Avatar model 102 represents the target appearance and movement desired by the user. In an ideal scenario where simplification is not necessary, the avatar should appear and move as captured by avatar model 102. However, because simplification may be needed to account for user preferences and computational resources, simplification module 104 is utilized.

In some aspects, simplification module 104 is made up of various components including computational resources component 106, communication channel component 108, user experience component 110, steps database 112, and training dataset 114.

Computational resources component 106 evaluates the changes in needed computational resources (CPU, GPU, RAM user (client) or owner (server)). For example, if a first set of computational resources are needed to generate avatar model 102, but only a second set of computational resources (fewer than the first set) are available, computational resources component 106 will detect the discrepancy.

Communication channel component 108 evaluates the changes in the needed communication channel (broadband). For example, if data pertaining to the generation/presentation of the avatar needs to be transferred over a network, changes in bandwidth, upload speed, download speed, network outages, etc., are monitored by component 108.

User experience component 110 evaluates for changes in user experience. For example, suppose that avatar model 102 is configured to present source lecture 116. For example, the avatar may be a teaching avatar powered using artificial intelligence. The avatar may recite course subject matter to a class and field questions from students and provide answers. In this case, various algorithms may propel the avatar such as a large language model. Learning objectives 118 indicate the goal(s) of the course (i.e., what the students should learn). User interface 120 may be used by the students to evaluate the avatar and provide user experience requirements 122. For example, students may fill out a survey that requests the improvements they would like to see in the avatar. Students may indicate that they would like longer responses with more examples, a greater variety of gestures, a greater variety of expressions, etc. User experience component 110 may quantify the user experience requirements 122 and help adjust avatar model 102. For example, if a simplification step possibility involves reducing the number of gestures, but students wish for the avatar to be more expressive, that specific simplification step may not be implemented.

The list of simplification options for simplification module 104 to user may be stored in steps database 112. Steps database 112 may highlight the steps and consequences for changes in computational recourses, communication channels, and user experience. For example, improvement in said categories may lead to the generation of an avatar that closer resembles avatar model 102, whereas worsening in said categories may lead to a greater degree of simplification.

Examples of simplification include, but are not limited to, reducing active movements (such as turning to the side and adopting a thoughtful pose) and focusing solely on facial and cognitive expressions. Additionally, the size of the avatar may be minimized, and the resolution during rendering may be decreased to optimize resource usage.

Utilizing prerecorded videos for gestures is another possibility to ease computational load. Simplification may also involve reducing the level of detail in the avatar's appearance, converting dynamic elements into static ones, and removing reflective layers. A smooth transition to a cartoon-like model is another potential option. Finally, combining geometry likelihood layers, which include both body and appearance, may be considered to enhance resolution and performance, ensuring the avatar remains effective and visually coherent within the specified constraints.

Training dataset 114 captures a plurality of specific examples indicative of detected changes and the corresponding technical steps to take for simplification. These examples are highly specific. For example, if there is an increase in CPU usage by X % and there is no change in a communication channel or user experience, a training data point may indicate that the number of gestures performed by the avatar should be decreased by Y %. Training dataset 114 may be used to train a regression model of simplification module 104.

In some aspects, training the machine learning model to simplify an avatar model may involve a strategic approach to ensure that the reduction in quality is performed in a sequence that aligns with human subjective perception. For example, an objective may be to prompt or fine-tune the model to execute quality reduction in a manner that minimizes the perceptual impact on the user. This process may begin with identifying the sequence in which different aspects of the avatar may be simplified, such as reducing the complexity of skin layers, followed by the simplification of hand movements, and subsequently, the movements of the head. This ordered approach helps maintain the user's engagement with the avatar by prioritizing the reduction of less perceptually significant features first.

To achieve this, the model may be trained using a dataset that encapsulates various sequences of quality reduction tailored to different computational constraints and user perceptions. The dataset may include diverse examples where the sequence of simplification is varied to accommodate different scenarios, such as limited processing power or specific user preferences. By exposing the model to these variations, it can learn to identify and apply the most appropriate sequence of simplification for a given context, thereby optimizing the balance between computational efficiency and user experience.

The training process may involve both supervised and unsupervised learning techniques. Supervised learning can be employed to guide the model using labeled data that specifies the desired sequence of simplification for different scenarios. Meanwhile, unsupervised learning can help the model discover patterns and sequences that may not be explicitly labeled but are effective in practice. In some aspects, reinforcement learning may be integrated to allow the model to iteratively improve its performance by receiving feedback on the perceptual impact of its simplification decisions. By combining these approaches, the model can be fine-tuned to not only reduce computational load but also maintain a high level of user satisfaction by adhering to the subjective perception of avatar quality. For example, by reducing an amount of skin layers and hair follicles on the avatar by 10%, the computational resource usage may be reduced by 5%, but the perception of model quality degradation by the user may be minimal.

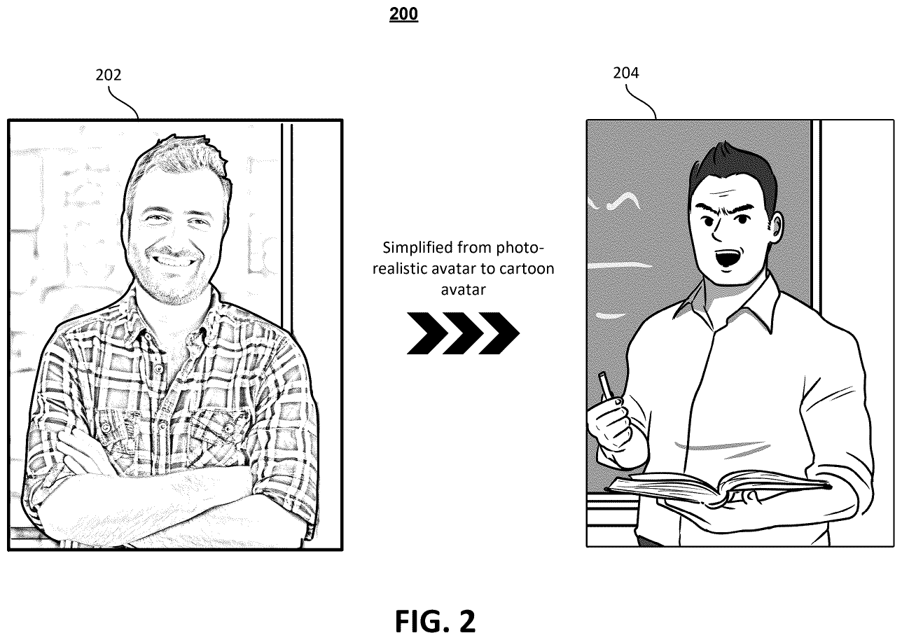

FIG. 2 is a diagram illustrating an example of a simplified visual appearance of an avatar. For example, avatar 202 is a photo-realistic depiction of an avatar as captured by avatar model 102. More specifically, the avatar 202 is a human male wearing a collared shirt with a checkered print. Suppose that simplification module 104 detects a decrease in broadband and other computational resources. Simplification module 104 may simplify the avatar 202 by making a cartoon representation 204 of the avatar. The cartoon representation 204 appears like the human avatar, but several visual details are simplified (no individual hair strands, simplified facial features, more consistent colors, no pattern on the collared shirt).

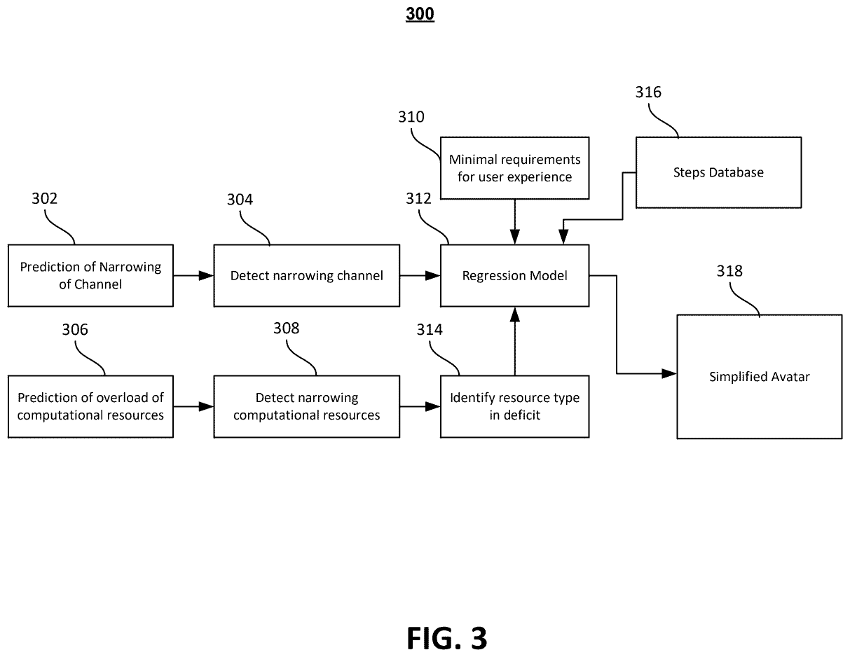

FIG. 3 illustrates a block diagram 300 of a specific approach for adjusting an avatar model on the fly. At 302, simplification module 104 predicts a narrowing of a communication channel (e.g., reduction in bandwidth) based on a pattern of channel usage by the computing device. At 304, simplification module 104 monitors the channel and detects the narrowing of the communication channel as predicted. At 306, simplification module 104 predicts an overload of computational resources (e.g., increased CPU usage) based on a pattern of resource usage by the computing device. At 308, simplification module 104 monitors the resources and detects narrowing computational resources.

At 314, simplification module 104 identifies the resource type in deficit. For example, simplification module 104 may detect a memory deficit. Regression model 312 receives the information about the narrowing channel, computational resources, and minimal requirements for user experience 310. Using steps database 316, regression model 312 outputs potential adjustments to make on an avatar, which ultimately yield simplified avatar 318.

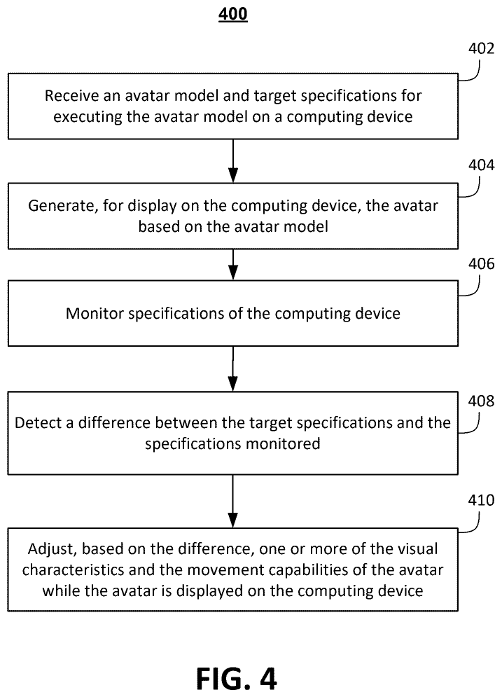

FIG. 4 illustrates a flow diagram of method 400 for adjusting an avatar model on the fly. At 402, simplification module 104 receives an avatar model (e.g., model 102) and target specifications for executing the avatar model on a computing device. The avatar model typically includes detailed visual characteristics such as texture, color, and shape, as well as movement capabilities that define how the avatar can interact within its environment, such as walking, running, or gesturing.

The target specifications provide a framework for optimizing the avatar model to function efficiently on specific hardware and network conditions. These specifications may include a target set of computational resources, which are essential for rendering and processing the avatar in real-time. For instance, the central processing unit (CPU) is responsible for executing the instructions that control the avatar's behavior, while the graphics processing unit (GPU) handles the rendering of the avatar's visual elements, ensuring smooth and high-quality graphics. Random access memory (RAM) is used to store the avatar's data temporarily, allowing for quick access and manipulation during execution.

Additionally, storage requirements are considered to ensure that the avatar model and its associated data may be stored and retrieved efficiently. Communication channel performance is another aspect, encompassing for example bandwidth and latency. Bandwidth determines the amount of data that may be transmitted over the network, which is vital for applications where the avatar interacts with other users or systems in real-time. Latency, the delay before a transfer of data begins following an instruction, affects the responsiveness of the avatar, particularly in interactive environments.

Validation resources are also part of the target specifications, ensuring that the avatar model meets certain standards and functions correctly within the given constraints. This may involve testing the avatar's performance under different scenarios to ensure it remains stable and responsive.

An example of target specifications for executing an avatar model on a computing device may include the following: (1) a quad-core processor with a minimum clock speed of 2.5 GHz, (2) a dedicated GPU with at least 4 GB of VRAM, (3) at least 8 GB of RAM, (4) a minimum of 500 MB of available storage space, (5) a network connection with a minimum bandwidth of 10 Mbps to support real-time data transmission and a maximum latency of 50 milliseconds.

At 404, simplification module 104 generates, for display on the computing device, the avatar based on the avatar model.

At 406, simplification module 104 monitors specifications of the computing device. For example, simplification module 104 may utilize one or more of computational resources component 106, communication channel component 108, and user experience component 110 to monitor the specifications.

At 410, simplification module 104 detects a difference between the target specifications and the specifications monitored. For example, if the target specifications require a minimum of 8 GB of RAM, but the computing device only has 4 GB available, the module identifies this shortfall. Similarly, if the network latency exceeds the acceptable threshold (e.g., 100 milliseconds instead of 50 milliseconds), the module notes this difference.

At 412, simplification module 104 adjusts, based on the difference, one or more of the visual characteristics and the movement capabilities of the avatar while the avatar is displayed on the computing device. This adjustment process is crucial for maintaining a balance between performance and visual fidelity, ensuring that the avatar remains functional and visually appealing even when the device's resources are limited. For instance, if the device's GPU is unable to handle high-resolution textures due to limited VRAM, the simplification module may reduce the texture quality or resolution of the avatar, thereby decreasing the graphical load without significantly compromising the overall appearance. Similarly, if the CPU is under strain, the module may simplify the avatar's movement animations, reducing the complexity of calculations required for smooth transitions and interactions. This could involve using less detailed animation sequences or reducing the number of frames in an animation cycle to ensure fluid motion without overburdening the processor.

In some aspects, adjusting one or more of the visual characteristics and the movement capabilities of the avatar comprises performing one or more of: (1) decreasing active movements performed by the avatar, (2) reducing an amount of expressions performed by the avatar, (3) reducing a size of the avatar, (4) decreasing a rendering resolution of the avatar, (5) using prerecorded videos of gestures in place of dynamic animations performed by the avatar, or (6) reducing appearance details on the avatar.

In some aspects, reducing the appearance details on the avatar comprises one or more of: (1) changing dynamic elements of appearance to static, (2) deleting layers with reflections, (3) replacing a photo-realistic avatar with a cartoon avatar (e.g., as shown in FIG. 2), or (4) combining geometry likelihood layers.

In some aspects, the visual characteristics further comprise internal characteristics including one or more of: skeleton components and computational characteristics. For example, the computational characteristics include one or more of: an amount or size of physical models, Courant number, amount of hairs, amount of textures, and amount of polygons.

In some aspects, adjusting one or more of the visual characteristics and the movement capabilities of the avatar comprises executing a machine learning model that recommends an adjustment based on a magnitude of the difference. The machine learning model may be trained on a comprehensive dataset that includes a wide variety of input specification differences and their corresponding adjustments, allowing the model to learn and predict the most effective modifications for maintaining optimal performance and user experience.

For example, if the model detects a significant drop in available GPU resources, the model may recommend reducing the polygon count of the avatar, thereby simplifying the 3D model to ensure smoother rendering. Alternatively, if the network bandwidth is lower than expected, the model may suggest compressing the data associated with the avatar's textures or animations to facilitate faster transmission without noticeable loss of quality. By leveraging such a machine learning model, the system can dynamically and efficiently tailor the avatar's characteristics to suit the specific capabilities of the user's device, ensuring that the avatar remains responsive and visually coherent across a diverse range of hardware and network conditions. This approach not only enhances the adaptability of the avatar but also provides a personalized experience for users, as the adjustments are finely tuned to the unique constraints of their computing environment.

In some aspects, the difference specifically indicates that the specifications are lower than the target specifications. Simplification module 104 may thus re-adjust one or more of the visual characteristics and the movement capabilities of the avatar when the difference changes.

In some aspects, simplification module 104 further receives user experience requirements associated with the avatar model. Accordingly, simplification module 104 evaluates (e.g., using user experience component 110) a quality of avatar generation and adjusts, based on the quality of avatar generation, one or more of the visual characteristics and the movement capabilities of the avatar while the avatar is displayed on the computing device.

In some aspects, evaluating the quality of the avatar generation comprises monitoring for user experience feedback generated based on interactions with the avatar. This feedback may be collected through various channels, such as user surveys, in-app ratings, or direct comments, providing valuable insights into how users perceive the avatar's performance and visual appeal. For instance, users may report on the avatar's responsiveness during interactions, noting whether movements appear smooth and natural or if there are noticeable lags or glitches. Additionally, feedback may highlight the visual fidelity of the avatar, such as the realism of textures and the accuracy of facial expressions, which are crucial for creating an engaging and immersive experience. By analyzing this feedback, module 104 may identify specific areas where the avatar excels or falls short, allowing them to make targeted improvements.

In some aspects, evaluating the quality of the avatar generation comprises comparing avatar performance against predetermined benchmarks. These benchmarks may serve as a set of standards or criteria that define the expected performance levels for various aspects of the avatar, such as visual fidelity, responsiveness, and interaction capabilities. For example, a benchmark may specify that the avatar should maintain a minimum frame rate of 60 frames per second to ensure smooth animations and transitions. By comparing the avatar's actual performance to these benchmarks, module 104 may objectively assess whether the avatar meets the desired quality standards. If the avatar falls short, such as displaying at only 30 frames per second, it indicates a need for optimization in rendering processes or resource allocation. Additionally, benchmarks may include criteria for latency in response to user inputs, ensuring that the avatar reacts within a specified time frame to maintain a seamless user experience. For instance, if the benchmark requires a response time of less than 100 milliseconds for user interactions, any delay beyond this threshold would highlight areas for improvement in the avatar's programming or network handling.

Ultimately, module 104 is configured to find a balance such that adjustments do not cause the avatar to dip below the minimal requirements for meeting user expectations/benchmarks, while ensuring that computational resources and channels are efficiently utilized based on availability.

FIG. 5 is a block diagram illustrating a computer system 20 on which aspects of systems and methods for adjusting an avatar model on the fly may be implemented in accordance with an exemplary aspect. The computer system 20 may be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. For example, any of commands/steps discussed in FIGS. 1-4 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which may be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium may be a tangible device that can retain and store program code in the form of instructions or data structures that may be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein may be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure may be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort may be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for adjusting an avatar, the method comprising:
receiving an avatar model and target specifications for executing the avatar model on a computing device, wherein the avatar model comprises visual characteristics and movement capabilities of an avatar;
generating, for display on the computing device, the avatar based on the avatar model;
monitoring specifications of the computing device;
detecting a difference between the target specifications and the specifications monitored; and
adjusting, based on the difference, one or more of the visual characteristics and the movement capabilities of the avatar while the avatar is displayed on the computing device.

2. The method of claim 1, wherein the target specifications indicate a target set of computational resources and communication channel performance.

3. The method of claim 2, wherein the target set of computational resources and communication channel performance includes one or more of: central processing unit (CPU), graphics processing unit (GPU), and random access memory (RAM), storage, bandwidth, latency, and validation resources.

4. The method of claim 2, wherein the target specifications change over time.

5. The method of claim 1, further comprising:
receiving user experience requirements associated with the avatar model;
evaluating a quality of avatar generation; and
adjusting, based on the quality of avatar generation, one or more of the visual characteristics and the movement capabilities of the avatar while the avatar is displayed on the computing device.

6. The method of claim 5, wherein evaluating the quality of the avatar generation comprises monitoring for user experience feedback generated based on interactions with the avatar.

7. The method of claim 5, wherein evaluating the quality of the avatar generation comprises comparing avatar performance against predetermined benchmarks.

8. The method of claim 1, wherein the visual characteristics further comprise internal characteristics including one or more of: skeleton components and computational characteristics.

9. The method of claim 8, wherein the computational characteristics include one or more of: an amount or size of physical models, Courant number, amount of hairs, amount of textures, amount of polygons.

10. The method of claim 1, wherein adjusting one or more of the visual characteristics and the movement capabilities of the avatar comprises performing one or more of:
(1) decreasing active movements performed by the avatar,
(2) reducing an amount of expressions performed by the avatar,
(3) reducing a size of the avatar,
(4) decreasing a rendering resolution of the avatar,
(5) using prerecorded videos of gestures in place of dynamic animations performed by the avatar, or
(6) reducing appearance details on the avatar.

11. The method of claim 10, wherein reducing the appearance details on the avatar comprises one or more of:
(1) changing dynamic elements of appearance to static,
(2) deleting layers with reflections,
(3) replacing a photo-realistic avatar with a cartoon avatar, or
(4) combining geometry likelihood layers.

12. The method of claim 1, wherein the difference indicates that the specifications are lower than the target specifications, further comprising:
re-adjusting one or more of the visual characteristics and the movement capabilities of the avatar when the difference changes.

13. The method of claim 1, wherein adjusting one or more of the visual characteristics and the movement capabilities of the avatar comprises executing a machine learning model that recommends an adjustment based on a magnitude of the difference between the target specifications and the specifications monitored.

14. The method of claim 13, wherein the machine learning model is trained on a training dataset comprising a plurality of input specification differences and corresponding adjustments.

15. The method of claim 1, wherein adjusting, based on the difference, the one or more of the visual characteristics and the movement capabilities of the avatar is performed in a sequence that reduces human perception to quality degradation in the avatar.

16. A system for adjusting an avatar, comprising:
at least one memory; and
at least one hardware processor coupled with the at least one memory and configured, individually or in combination, to:
receive an avatar model and target specifications for executing the avatar model on a computing device, wherein the avatar model comprises visual characteristics and movement capabilities of an avatar;
generate, for display on the computing device, the avatar based on the avatar model;
monitor specifications of the computing device;
detect a difference between the target specifications and the specifications monitored; and
adjust, based on the difference, one or more of the visual characteristics and the movement capabilities of the avatar while the avatar is displayed on the computing device.

17. The system of claim 16, wherein the target specifications indicate a target set of computational resources and communication channel performance.

18. The system of claim 17, wherein the target set of computational resources and communication channel performance includes one or more of: central processing unit (CPU), graphics processing unit (GPU), and random access memory (RAM), storage, bandwidth, latency, and validation resources.

19. The system of claim 16, wherein the at least one hardware processor is further configured to:
receive user experience requirements associated with the avatar model;
evaluate a quality of avatar generation; and
adjust, based on the quality of avatar generation, one or more of the visual characteristics and the movement capabilities of the avatar while the avatar is displayed on the computing device.

20. A non-transitory computer readable medium storing thereon computer executable instructions for adjusting an avatar, including instructions for:
receiving an avatar model and target specifications for executing the avatar model on a computing device, wherein the avatar model comprises visual characteristics and movement capabilities of an avatar;
generating, for display on the computing device, the avatar based on the avatar model;
monitoring specifications of the computing device;
detecting a difference between the target specifications and the specifications monitored; and
adjusting, based on the difference, one or more of the visual characteristics and the movement capabilities of the avatar while the avatar is displayed on the computing device.
